(19) United States
(12) Patent Application Publication
(10) Pub. No.: US 2025/0057198 A1
(43) Pub. Date: Feb. 20, 2025

(54) DRIED FOOD PRODUCTS AND METHOD

(71) Applicant: VibesThrive LLC, Richmond, VT (US)

(72) Inventor: Janina Lovelace, Richmond, VT (US)

(21) Appl. No.: 18/791,248

(22) Filed: Jul. 31, 2024

Related U.S. Application Data
(60) Provisional application No. 63/520,418, filed on Aug. 18, 2023.

(51) Int. Cl. A23L 19/00; A23B 7/02; A23L 25/00

(52) U.S. Cl. CPC A23L 19/05; A23B 7/0215; A23L 19/09; A23L 25/20; A23L 25/30

(57) ABSTRACT

A system and method makes dried foods designed to support the holistic health of the end user. Ingredients for dried food products are selected and combined using an ayurvedic approach. These ingredients are dehydrated using modern methods to preserve the original food's nutrients and flavor, while also requiring less time and energy as compared to typical dehydration methods. In one embodiment, food combinations are selected in view of the seven main chakras of the human body, as defined within ancient Indian traditions including Hindu and Buddhist texts.

### CROSS-REFERENCE TO RELATED APPLICATIONS

The present application claims priority to U.S. provisional application Ser. No. 63/520,418, filed Aug. 18, 2023 and entitled DRIED FOOD PRODUCTS AND METHOD, the entire disclosure of which is hereby expressly incorporated herein by reference.

### BACKGROUND

### 1. Technical Field

The present disclosure relates generally to dried foods and, more specifically, to fruit- and vegetable-based dried foods.

### 2. Description of the Related Art

Dehydration is a well known food preservation technique. By removing water from fresh foods such as fruits and vegetables, the dried products benefit from a longer shelf life as well as easier portability and convenience.

However, many known dehydration techniques and apparatuses deplete fresh foods of their native flavor and nutrients. Additionally, many dehydrated foods do not offer holistic health benefits.

What is needed is an improvement over the foregoing.

### SUMMARY

The present disclosure provides a system and method for making dried foods designed to support the holistic health of the end user. Ingredients for dried food products are selected and combined using an ayurvedic approach. These ingredients are dehydrated using modern methods to preserve the original food's nutrients and flavor, while also requiring less time and energy as compared to typical dehydration methods. In one embodiment, food combinations are selected in view of the seven main chakras of the human body, as defined within ancient Indian traditions including Hindu and Buddhist texts.

In one form thereof, the present disclosure provides a food product including a first ingredient associated with one of seven chakras, the seven chakras including a root chakra, a sacral chakra, a solar plexus chakra, a heart chakra, a throat chakra, a third eye chakra and a crown chakra, and a second ingredient associated with ayurveda. The first ingredient and the second ingredient are combined into a single-piece, monolithic food product, and wherein the monolithic food product has a moisture content of less than 4% by weight.

In another form thereof, the present disclosure provides a method for making a food product. The method includes selecting a first ingredient corresponding to one of seven chakras, the seven chakras including a root chakra, a sacral chakra, a solar plexus chakra, a heart chakra, a throat chakra, a third eye chakra and a crown chakra, and selecting a second ingredient associated with ayurveda. The first and second ingredients are combined into a single-piece, monolithic food mixture identified with the one of the seven chakras. The food mixture is dehydrated into a dried food product.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is an illustration of the seven chakras of the human body; and

FIG. 2 is a schematic diagram illustrating a method of producing a food product in accordance with the present disclosure.

Corresponding reference characters indicate corresponding parts throughout the several views.

### DETAILED DESCRIPTION

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to a particular set of dehydrated foods, other preserved foods may be provided within the spirit and scope of the present disclosure.

The present disclosure provides a system and method for preparing modern dehydrated foods which incorporate ingredients based on ayurveda and the seven chakras. The resulting products provide the benefits of ancient Indian knowledge using modern methods and ingredients. These products can be stored and transported in the same manner as snacks and convenience foods, but can also be eaten daily or regularly with an expectation for genuine nourishment and improvement of health.

For purposes of the present disclosure, “ayurveda” refers to a system focusing on promoting balance within the body, contributing to its prana (life-force energy) via a specific function, such as stress reduction, hormone balancing, and digestive enhancement. Ayurvedic food has historical roots to ancient India, with each ingredient being functional to promote ayurveda for an individual. Ayurvedic foods includes organic ingredients, gluten-free, plants-focused, ethically sourced, nutrient dense, peak harvested vegetation. As noted herein, peak harvested means that vegetation is processed less than 48 hours from the vine, and in some cases, less than 24 hours. By contrast, ayurvedic foods do not includes synthetic or heavily processed additives or chemicals, such as refined sugar.

Ayurvedic ingredients include, but are not limited to: Ghee, Basmati, Lime, Coconut Oil, Mung Beans, Ginger, Cilantro, Turmeric, Cardamom, Cinnamon, Cloves, Cumin, Quinoa, Lentils, Chickpeas, Squash, Kale, Asparagus, Blueberries, Pomegranate, Apples, Dates, Coconut Flakes, Sunflower Seeds, and Almonds. Additional details regarding ayurvedic ingredients is available in “Stocking Your Ayurveda Pantry,” available at http://www.joyfulbelly.com/Ayurveda/article/Stocking-Your-Ayurveda-Pantry/6007, a copy of which is attached hereto, the entire disclosure of which is hereby incorporated herein by reference.

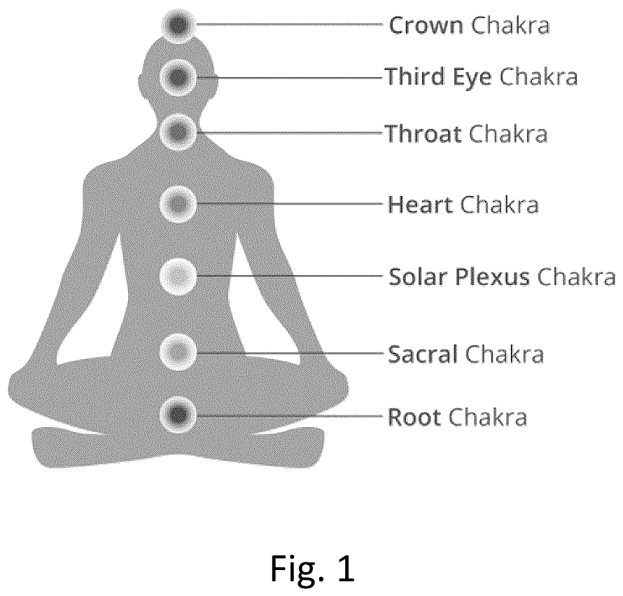

For purposes of the present disclosure, the “seven chakras” refer to places on the human body where energy (also referred to as prana) is thought to congregate or is concentrated. Each of the seven chakras correspond to a different section of the human body and can be represented by a different color. As shown in FIG. 1, the seven chakras are:
1. Root chakra, corresponding to the bottom of the tailbone. Color: red.
2. Sacral chakra, corresponding to the area between the tailbone and the belly button. Color: Orange.
3. Solar plexus chakra, corresponding to the belly button area. Color: yellow.
4. Heart chakra, corresponding to the center of the chest. Color: green.
5. Throat chakra, corresponding to the pit of the throat. Color: blue.
6. Third eye chakra, corresponding to the space between the eyebrows. Color: indigo.
7. Crown chakra, corresponding to the top of the head. Color: purple.

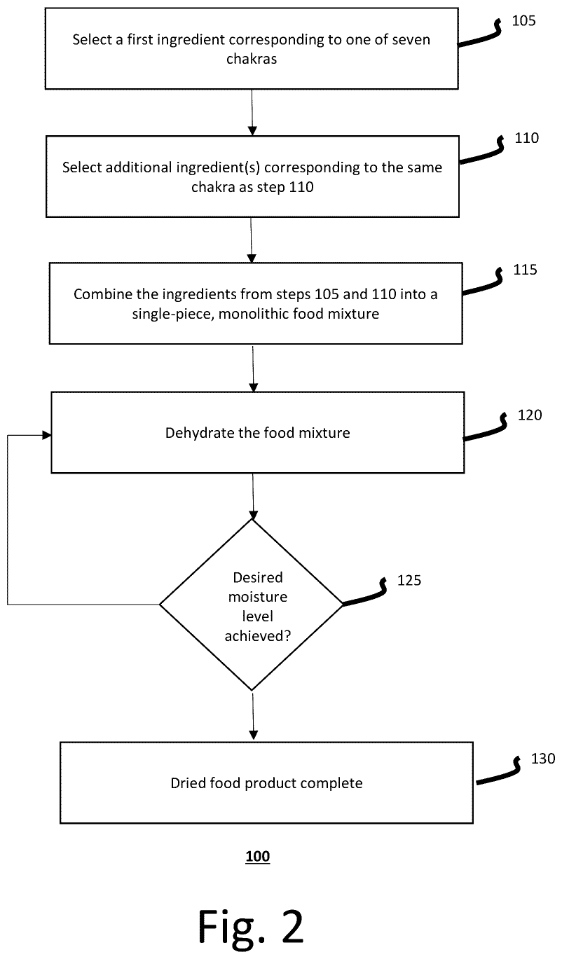

Ingredients for foods processed in accordance with the present disclosure are chosen to correspond with one of the seven chakras. With reference to FIG. 2, this is accomplished using at least selection step 105 and selection step 110, it being appreciated that more than two ingredients may be selected. A finished product includes only food ingredients associated with a common one of the seven chakras. The food product does not contain any ingredients belonging to a chakra category other than the chakra category with which the food product is associated. For example, a “root chakra” product may include two or more ingredients associated with the root chakra, and no other ingredients. Additionally, finished products may be provided for each of the seven chakras.

Exemplary ingredients associated with each of the seven chakras described below, it being understood that the following list is not comprehensive, and persons of ordinary skill in the art will understand that additional ingredients are also candidates for association in one or more particular chakras. All ingredients are either a fruit or a vegetable.
1. Root chakra ingredients: any fruit or vegetable red in color, such as strawberries and beets.
2. Sacral chakra ingredients: any fruit or vegetable orange in color, such as oranges and carrots.
3. Solar plexus chakra ingredients: any fruit or vegetable yellow in color, such as bananas and pineapples.
4. Heart chakra ingredients: any fruit or vegetable green in color, such as broccoli and kiwi.
5. Throat chakra ingredients: any fruit or vegetable blue in color, such as blueberries and blackberries.
6. Third eye chakra ingredients: any fruit or vegetable violet in color, such as plums and eggplant.
7. Crown chakra ingredients: any fruit or vegetable white in color, such as coconut and mushrooms.

Additional details regarding chakra-related foods can be found in “Keep Your Chakras in Balance With Food,” available at http://ediblesiliconvalley.ediblecommunities.com/speaking-food/foods-balance-your-chakras, and in “Eating to Balance Your Chakras,” http://www.chopra.com/articles/eating-to-balance-your-chakras, and in “Balancing Your Chakras with the Life Force Energy of Food,” available at http://manifestationmagic.net/balancing-your-chakras-with-the-life-force-energy-of-food/, and in “Foods That Will Clear & Balance Each Chakra,” available at http://dailylife.com/article/foods-that-will-clear-and-balance-each-chakra. Copies of each of these references are attached hereto, and the entire disclosures of all of these references are hereby incorporated herein by reference. Still further information can be found in Chakra Healing: A Beginner's Guide to Self-Healing Techniques that Balance the Chakras, by Margarita Alcantara, Althea Press, 2017, the entire disclosure of which is hereby incorporated herein by reference.

Each ingredient used in the present food products may be “peak harvested,” meaning they are sourced from their agricultural origin at a state of maximum nutrient density (e.g., ripeness), and processed as discussed herein within no more than 48 hours after harvest, and in some cases, no more than 24 hours after harvest. This processing modality locks in nutrients at the peak-harvest state, specifically maximizing the benefits associated with the ayurvedic modernization offered by the present disclosure. By contrast, ingredients are typically not sourced from a store shelf or other intermediary which may store the ingredients for several days (often, 10 days or more) after harvest, by which time the ingredients' ayurvedic life force and nutrient density/quality are reduced.

To create a finished food product, combinations are made using ingredients corresponding with one of the seven chakras. This is shown in FIG. 2 as combination step 115. Combinations may be made for nutritional balance and flavor, as well as any other qualities which may be required or desired for a particular product, such as texture, density, shelf life, and the like.

Exemplary food product combinations include, for example, a fruit piece wrapped in a dough-type material. The dough may be made from base ingredients including coconut oil, nut butter (e.g., almond butter), seeds (e.g., sunflower seeds), whole or chopped nuts (e.g., almonds), and nut milk (e.g., almond milk), and dates (e.g., medjool dates). In one embodiment, the two parts coconut oil and two parts nuts may be combined with one part nut butter and one part seeds, with nut milk and dates added for a desired consistency. The base ingredients may be supplemented with spices including, e.g., cinnamon, cardamom, ginger, nutmeg, and sea salt. Other materials, including fruits and vegetables, may be incorporated into the encasement dough. The base ingredients and spices are mixed and blended into a wet dough consistency. The dough is then used to encase or enclose a fruit piece corresponding to a particular chakra, as noted above. The enclosed fruit piece is dehydrated to be soft and chewy with vibrancy and brightness from peak-harvested fruits. The combined product, after processing in accordance with the present disclosure, produces a product with a “bottom of a cheesecake” type consistency.

In exemplary products, the fruit piece enclosed by the dough may be as follows:
1. Root chakra product: strawberry
2. Sacral chakra product: apricot
3. Solar plexus chakra product: banana
4. Heart chakra product: kiwi
5. Throat chakra product: blueberry
6. Third eye chakra product: pomegranate
7. Crown chakra product: young coconut meat

The finished product may be sized to weigh about 16.5 ounces before processing. After processing via dehydration as disclosed herein, the finished product may have a final weight of about 12 ounces. In one embodiment, the product may be sprinkled with coconut flakes (either before or after processing) for aesthetic appeal.

In other embodiments, fruits may be pureed and combined into a bar-type form. For example, 6 ounces of pureed, organic fruit may be combined using about 3 ounces each of two complementary fruits belonging to a common chakra with a good ayurvedic match. After processing, the weight is reduced and the final form is a rectangular fruit bar. In some formulations, there is a 50/50 proportion, or 3 ounces of each fruit, such as 50% strawberry with 50% red apple. The overall ratio for the 6 ounces may differ where one fruit flavor is stronger than the other. Examples of pairings with a non-50/50 proportion includes 70% apricot with 30% mango, 40% banana with 60% pineapple, 60% kiwi with 40% lime, 60% blackberry with 40% coconut, 70% pomegranate with 30% coconut, and 90% coconut with 10% vanilla. A small amount of almond flour (e.g., between 1-3 teaspoons) may be added to increase solidification content and prevent splashing with the drying machine. Exemplary fruit combinations include:
1. Root chakra product: strawberry and red apple
2. Sacral chakra product: apricot and mango
3. Solar plexus chakra product: banana and pineapple
4. Heart chakra product: kiwi and lime
5. Throat chakra product: blackberry and coconut
6. Third eye chakra product: pomegranate and coconut
7. Crown chakra product: coconut and vanilla bean paste

Once combined, the ingredients for any given product combination form a mixture ready for further processing. In some embodiments, the mixture is a heterogeneous combination of different foods, such as a fruit piece contained within an encasement formed from a different fruit as noted above, or from a vegetable. In other embodiments, the mixture may be a homogeneous slurry of blended fruits and/or vegetables. When such mixtures are dehydrated, the resulting food product may be heterogeneous or homogeneous in a similar manner as the input mixtures.

Regardless of whether the mixture is homogeneous or heterogeneous, the resulting food product forms a single-piece, monolithic mass when ready for final processing, and when finished into a food product ready for consumption. That is, the mixture and food product are each a single piece of material which can be wrapped, transported, handled, unwrapped, and eaten as a single piece. In some embodiments, this single piece may be “bite sized,” meaning the entire food product is sized to fit in the mouth of an average adult. By contrast, a non-monolithic or multi-piece product comes in multiple, distinct and non-connected pieces rather than a single piece.

For the exemplary mixtures above, further processing is accomplished by a low-temperature dehydration process, as shown at step 120 in FIG. 2. In one embodiment, vacuum pressure is combined with radiant energy for dehydration. In this embodiment, a food product or mixture is placed into a vacuum chamber where pressure is reduced until the boiling point of water is about body temperature. At this point, the product or mixture is dried by application of radiant energy, e.g., through microwave processing which causes the moisture in the food mixture to be discharged into the ambient area around the food and within the vacuum chamber. The temperature of the food product or mixture may or may not be reduced to a temperature lower than ambient temperature during the drying process.

In one embodiment, a drying system includes solid-state RF power with multiple frequencies combined with vacuum technology to process food products under mild temperatures. Solid-State RF generators are able to excite and heat products internally, and not just in the outer layers. The bulk heating effect produces uniform heating throughout the material, avoiding the large temperature gradient that occurs in conventional heating systems. Reduced exposure time to high heat decreases material deterioration and preserves the ayurvedic value of food ingredients. Additionally, uniform heating/drying removes the risk of surface cracking, because water heats first, resulting in levelling the moisture level. Combining this with vacuum provides the optimal environment to accelerate the speed of the microwave heating, while avoiding high temperatures.

The drying system may include a built-in analytic feature performing real-time monitoring with automatic frequency adjustment, enabling users to create an optimal ‘recipe’ for the processing of a specific product. The technology also incorporates Machine Learning and Artificial Intelligence to optimize the process, constantly monitoring and adjusting key operating parameters to provide the optimal amount of microwave energy to the target, tuning the frequency and controlling phase over 360 degrees.

The drying system not only dries to solidify and preserve but it has the ability to cook mildly while retaining maximum nutrients.

Additional details regarding exemplary systems and method for dehydration, which is compatible with the products and methods of the present disclosure, is described in Great Britain Patent Nos. GB-201901552, GB-202202077 and GB-202202076, the entire disclosures of which are hereby incorporated herein by reference. Apparatuses suitable for dehydration in accordance with the present disclosure are available from Mildtech UK Ltd of the United Kingdom.

The dehydration process is continued until a desired moisture content is reached. Referring to FIG. 2, a feedback loop may be engaged whereby the moisture level is monitored at step 125 and, if the moisture is still above a desired level, the dehydration step 120 continues. When the moisture reaches the desired level, the food product processing is completed at step 130. In an exemplary embodiment, the food product may be considered fully dehydrated when the moisture content is no greater than 4% by weight. In some embodiments, the moisture content may be as low as 1% by weight. Suitable moisture content may be as low as 1%, 1.5% or 2%, and as much as 2.5%, 3%, 3.5% or 4%, or within any range defined by any of the foregoing values.

Finished food products may be packaged for sale to a consumer. The package may identify the one of the seven chakras associated with the ingredients used in the food product. For example, the package may let the consumer know that all ingredients of the finished food product correspond to either the root chakra, the sacral chakra, the solar plexus chakra, the heart chakra, the throat chakra, the third eye chakra or the crown chakra. Moreover, a line of products may be created in which each of the seven chakras has at least one corresponding food product, including only ingredients associated with their respective chakra, and packaging is provided for each of the seven chakras. Additionally, a “mixed” or sampler package may be created indicating that a subset of chakras, or all seven chakras, are represented by the food products contained in the single package.

While this disclosure has been described on the basis of an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A food product comprising:
a first ingredient associated with one of seven chakras, the seven chakras including a root chakra, a sacral chakra, a solar plexus chakra, a heart chakra, a throat chakra, a third eye chakra and a crown chakra; and
a second ingredient associated with ayurveda,
wherein the first ingredient and the second ingredient are combined into a single-piece, monolithic food product, and wherein the monolithic food product has a moisture content of less than 4% by weight.

2. The food product of claim 1, wherein the moisture content is between 1% and 4% by weight.

3. The food product of claim 1, wherein the first ingredient is a fruit or a vegetable and the second ingredient is one of a fruit, a vegetable, a nut, and a mixture thereof.

4. The food product of claim 1, wherein the food product is a heterogeneous combination of the first ingredient and the second ingredient.

5. The food product of claim 4, wherein the first ingredient is a fruit piece and the second ingredient forms an encasement formed from a different fruit or vegetable, the encasement encasing the fruit piece.

6. The food product of claim 5, wherein the encasement is formed from a dough including coconut oil, nut butter, seeds, nuts, nut milk, dates, and spices.

7. The food product of claim 1, wherein the food product is a homogeneous combination of the first ingredient and the second ingredient.

8. The food product of claim 7, wherein the homogeneous combination forms a slurry of blended fruits and/or vegetables.

9. The food product of claim 7, wherein the second ingredient is also associated with the one of the seven chakras associated with the first ingredient.

10. A method for making a food product, the method comprising:
selecting a first ingredient corresponding to one of seven chakras, the seven chakras including a root chakra, a sacral chakra, a solar plexus chakra, a heart chakra, a throat chakra, a third eye chakra and a crown chakra;
selecting a second ingredient associated with ayurveda;
combining the first and second ingredients into a single-piece, monolithic food mixture associated with the one of the seven chakras; and
dehydrating the food mixture into a dried food product.

11. The method of claim 10, further comprising packaging the dried food product into a package identifying the one of the seven chakras associated with the first ingredient.

12. The method of claim 10, wherein the step of dehydrating comprise:
applying a vacuum to the ambient area around the food mixture; and
applying radiant energy to the food mixture, during the step of applying the vacuum, such that moisture in the food mixture is discharged into the ambient area.

13. The method of claim 10, wherein the step of combining comprises forming a heterogeneous combination of the first ingredient and the second ingredient.

14. The food product of claim 13, wherein the first ingredient is a fruit piece and the second ingredient is one of a fruit, a vegetable, a nut, and a mixture thereof, the method further comprising using the second ingredient to form an encasement encasing the fruit piece.

15. The method of claim 10, wherein the step of combining comprises forming a homogeneous combination of the first ingredient and the second ingredient.

16. The method of claim 15, wherein the step of combining comprises forming a slurry of blended fruits and/or vegetables.

17. The method of claim 15, wherein the second ingredient is also associated with the one of the seven chakras associated with the first ingredient.

18. The method of claim 10, wherein the step of dehydrating is continued until the moisture content of the food product is between 1% and 4% by weight.

19. The method of claim 10, wherein the steps of selecting the first ingredient and selecting the second ingredient each comprises selecting the respective ingredients within 48 hours after the ingredients are harvested from their agricultural source.
